(19) United States
(12) Patent Application Publication
(10) Pub. No.: US 2010/0199233 A1
(43) Pub. Date: Aug. 5, 2010

(54) Uniquely Marking Products And Product Design Data

(76) Inventor: Vladimir V. Petunin, Longmont, CO (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/362,841

(22) Filed: Jan. 30, 2009

(51) Int. Cl. G06F 17/50

(52) U.S. Cl. 716/1

(57) ABSTRACT

Methods and apparatuses for marking the product of an unauthorized use of a process are provided. For example, various implementations of the invention may cause a product to be marked when it is produced by the unauthorized use of a process. With some implementations of the invention, a computer program product may contain operations, which if the computer program product is used without authorization, would cause an inconspicuous mark to be placed within the output of the computer program or computer program product.

### FIELD OF THE INVENTION

The invention relates to the field of computer programs and computer program products. In particular, various implementations of the invention may provide processes, machines, and manufactures for uniquely marking products and data representing product designs, which are prepared, modified, adjusted, or selected by a computer program or computer program product.

### BACKGROUND OF THE INVENTION

### Introduction

Practically all industries utilize computer programs on a daily basis for their operations. Computer programs are so prevalent today that industries from manufacturing, distribution, communication, health care, and most service industries function only with the aid of computer programs. Even though computer programs are intertwined so completely with society today, some industries rely more heavily on computer programs than do other industries. For example, the electronics industry has made vast improvements in technology in recent decades due to the use of computer programs in the design and manufacturing stages of product development. Computer programs are used to assist engineers, scientists, and academics in advancing their fields, assist designers in conceiving ideas, and assist engineers in creating products based upon these advances and ideas.

The technological advancements so prevalent today, such as cell phones and medical devices, are filled with a variety of electronic devices, which are all designed and manufactured using computer software. One such example is the integrated circuit. Modern integrated circuits contain hundreds of thousands of gates. As a result, it would be impossible to design, manufacture, and test an integrated circuit without the aid of computer programs. For example, an integrated circuit is typically designed using computer programs that take as input a written specification detailing the intended functionality of the integrated circuit and produce as output an architectural layout, or layout design, for the integrated circuit. The layout design includes the various components and subcomponents that make up the integrated circuit, their placement within the integrated circuit, and their interconnections. Furthermore, various computer programs are employed to take the layout design and ready the layout design for manufacturing. Readying the layout design for manufacturing may include implementing self test functionality within the integrated circuit and optimizing the various layout designs for manufacturing in a photolithographic process. Further still, computer programs are used to test the layout design prior to manufacturing and to test the finished product prior to delivery. In general, the various computer programs that designers and engineers use to facilitate the electronic device creation process are referred to as electronic design automation (EDA) programs.

All devices that contain integrated circuits, even simple ones, must be electrically connected to an input or output device, to another integrated circuit device, or to some other electric component in order to be useful. To provide these electrical connections, integrated circuit devices are typically mounted on a printed circuit board (PCB). Accordingly, most electronic devices contain printed circuit boards in conjunction with integrated circuits. Printed circuit boards, like integrated circuits are often designed and manufactured with the assistance of computer programs, particularly various electronic design automation programs.

As indicated above, printed circuit boards provide for interconnections between various components within an electronic device. To accomplish this, most printed circuit boards have a rigid, planar core. The core may be formed, for example, of a sheet of fiberglass material impregnated with epoxy. Conductive lines or “traces” then are formed on one or both surfaces of the core, to electronically connect the components attached to the printed circuit board. The traces may be formed of any desired conductive material, such as copper. With various manufacturing techniques, specific traces may be created by etching a single layer of conductive material in a photolithographic process.

Simple printed circuit boards may have only a single core, with traces on one or both sides of the core. More complex printed circuit boards, however, may have multiple cores, with traces on one or both sides of one or more of the cores. These multilayered printed circuit boards also may include layers of insulating material, to prevent traces on adjacent core surfaces from contacting. In addition, a multilayered printed circuit board will typically include one or more “vias” to electrically connect two or more different layers of the board. A via is created by drilling or otherwise forming a hole through one or more cores. The walls of the via then may be clad with conductive material to form an electrical connection between the different layers. Alternately or additionally, the entire via may be filled with conductive material to form the electrical connection. Some vias may pass through every layer of the board, while other vias may connect only some of the layers in the board.

There are a number of steps performed in the design of a printed circuit board. Initially, a designer will create a schematic diagram for the system to be connected through the printed circuit board. This process includes identifying each component that will be included in the system. A system can include “active” components, such as field programmable gate array (FPGA) integrated circuits or application-specific integrated circuits (ASICs). A system also can include “passive” components, such as connectors formed as an integrated circuit, resistors, capacitors, and inductors. In addition to identifying each component, the schematic design will represent the electrical connections that must be formed between each component. Next, a designer typically will verify the functionality of the system described in the schematic design. This may be facilitated by using computer programs that model the system to ensure that the system described in the schematic will reliably perform the desired operations. If any errors are detected, then the schematic design will be corrected to address the errors, and the functional verification process repeated.

Once the schematic design is finalized, then the designer will create a physical design to implement the schematic design. This physical design is sometimes referred to as the design layout. The designer will begin by selecting a physical location in the design layout for each component. When a location for a component has been selected, the designer will add a component object, representing that component, to that location in the design layout. The component object may include a variety of information regarding the physical component it represents, such as the configuration of the connection pins used to electrically connect that component to other components. With an integrated circuit device, for example, the substrate with the integrated circuit will be encased in a package for protection from the environment. The pins serve to provide an electrical connection, through the packaging, to the electrical contacts of the integrated circuit. After the component objects for the components are located in the design layout, the designer then will attempt to route traces in the design layout to connect the components as specified in the schematic design.

New pin configurations have been developed to permit these more complex integrated circuit devices. Many integrated circuit devices, for example, now use a ball grid array (BGA) structure. With a ball grid array, the pins are formed by balls of solder mounted on the bottom of the package encasing the integrated circuit device. The printed circuit board in turn has a corresponding array of pads, formed of a conductive material such as copper, which matches the positions of the solder balls on the integrated circuit device package. To connect the integrated circuit device to the printed circuit board, the integrated circuit device is placed on the printed circuit board so that the balls of solder align with the conductive pads. The solder balls then are melted onto the pads, typically in a reflow oven or by using an infrared heater.

### Computer Program Protection Mechanisms

As described above, electronic device, such as integrated circuits and printed circuit boards are complicated devices. For example, a printed circuit board is a complex array of components, layers, vias, and traces. Accordingly, the computer programs used to design electronic devices are also complicated. Furthermore, creation of these computer programs requires a great understanding of electronic device design, electronic effects, computers, and computer programs. Accordingly, it is desirable that creators of computer programs be able to protect the computer programs from unauthorized usage.

Computer programs however, have a unique problem that traditional goods and services do not. Namely, one may purchase a computer program, copy it, and redistribute the copy while retaining the ability to use the original. As stated above, computer programs, especially electronic design automation programs require significant investment and specific knowledge to create. Additionally as mentioned, they are intertwined into virtually all industries, either through direct use of computer programs or through use of electronics designed and manufactured by computer programs. The illegal distribution and the unauthorized usage of computer programs causes revenue loss to those who create the computer programs and lowers the return and the incentive to create computer programs.

A number of mechanisms and methods have been employed to deter the illegal distribution and unauthorized usage of computer programs. For example, some computer programs require a registration code be entered into the program prior to allowing full functionality of the program. This is an insufficient method of deterring illegal distribution since the registration code may be shared or a registration code may be illegally generated and used to unlock the functionality of the program. Another method to prevent illegal distribution is to require the program to verify a valid “license” exists in order to operate the computer program. This too is an insufficient means of preventing illegal distribution as a valid license file may be reverse engineered so that an unauthorized license file may be illegally sold or distributed to allow unauthorized usage of the computer program.

As stated above, computer programs are used to design and manufacture products, such as an integrated circuit or a printed circuit board. Once a product has been manufactured, it is difficult or impossible to determine if the product was designed and manufactured using a particular computer program. Furthermore, even if determination of the computer program used to design and manufacture a particular product were possible, making a determination as to whether the computer programs usage was authorized or unauthorized based upon an inspection of the product would be even more difficult. Accordingly, various processes, machines, or manufactures for uniquely marking products and data representing product designs, which are prepared, modified, adjusted, or selected by a computer program or computer program product are disclosed herein.

### BRIEF SUMMARY OF THE INVENTION

Disclosed herein are embodiments of methods and apparatuses that may be employed to mark the product of an unauthorized use of a process. For example, various implementations of the invention may cause a product to be marked when it is produced by the unauthorized use of a process. With some implementations of the invention, a computer program product may contain operations, which if the computer program product is used without authorization, would cause an inconspicuous mark to be placed within the output of the computer program or computer program product.

Various implementations of the invention may be implemented in an electronic design automation tool. For example, the electronic design automation tool may be an autorouting tool, useful for automatically routing traces in a design for a printed circuit board. Accordingly, if the autorouting tool is used without an authorized license, the design for the printed circuit board may be marked. For example, various features within the design for the printed circuit board may be manipulated to cause the design to be marked. With various implementations of the invention, the marking corresponds to a code, such as a ternary code. For example, the autorouting tool may adjust the offset of various pads within the design for the printed circuit board according to the ternary code.

These and other features and aspects of the invention will be apparent upon consideration of the following detailed description of illustrative embodiments.

### BRIEF DESCRIPTION OF THE DRAWINGS

The present invention will be described by way of illustrative embodiments shown in the accompanying drawings in which like references denote similar elements, and in which:

FIG. 1 illustrates a process for uniquely marking a product according to various implementations of the invention;

FIG. 2 illustrates a computing device that various implementations of the invention may be carried out upon;

FIG. 3 illustrates a portion of the computing device of FIG. 2, shown in further detail;

FIG. 4 illustrates an electronic design automation tool implementing various embodiments of the present invention;

FIG. 5 illustrates a portion of a printed circuit board design;

FIG. 6 illustrates a selected region of the printed circuit board design of FIG. 5, shown in further detail;

FIG. 7 illustrates a pad from a printed circuit board;

FIG. 8 illustrates a selected region of the printed circuit board design of FIG. 6, shown in further detail.

### DETAILED DESCRIPTION OF ILLUSTRATIVE EMBODIMENTS

### Introduction

Various implementations of the invention may provide for marking the output of an unauthorized use of a computer program or computer program product. More particularly, various implementations of the invention may be used to assist in identifying the unauthorized use of a computer program by marking the output of the computer program in a predefined manner. As described above, computer programs are employed in many industries, particularly in the design and manufacturing industries. Accordingly, processes machines and manufactures are described herein that may be implemented to assist in identifying and thus deterring the unauthorized use of a computer program.

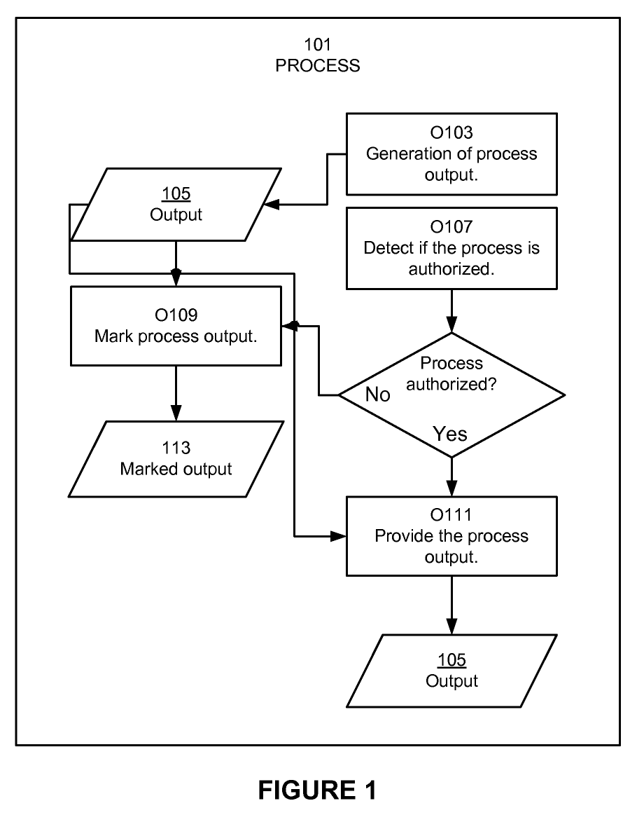

FIG. 1 illustrates a process 101 that may be implemented according to various embodiments of the invention. As can be seen in FIG. 1, the process 101 includes an operation 103 for generating an output 105. With various implementations of the invention, the process 101 is part of an electronic design automation tool. In some implementations, the process 101 may be a selected process carried out by the Board Station electronic design automation tool available from Mentor Graphics Corporation of Wilsonville, Oreg. With various implementations, the output 105 represents design data for an electrical device. For example, the output 105 may represent a layout design for a printed circuit board. Alternatively, the output 105 may represent a layout design for an integrated circuit.

The process 101 further includes an operation 107 for detecting if performance or execution of the process 101 is authorized, an operation 109 for marking the output 105, and an operation 111 for providing the output 105 unmarked. As can be seen in FIG. 1, the operation 109 for marking the output 105 results in a marked output 113, while the operation 111 for providing the output 105 unmarked, provides the output 105 unchanged. With various implementations of the invention, the operation 109 and the operation 111 save the output 113 or the output 105 to a memory storage location. As can be further seen from FIG. 1, the operation 109 is only performed if execution of the process 101 is detected to be unauthorized. With various implementations of the invention, the operation 109 adjusts or adds a distinguishing feature or “mark” to the output 105, resulting in the marked output 113. Accordingly, if it is detected that the process 101 is executed without proper authorization, the output of the process 101 is the marked output 113, which may facilitate identification of the unauthorized execution of the process.

### Illustrative Computing Environment

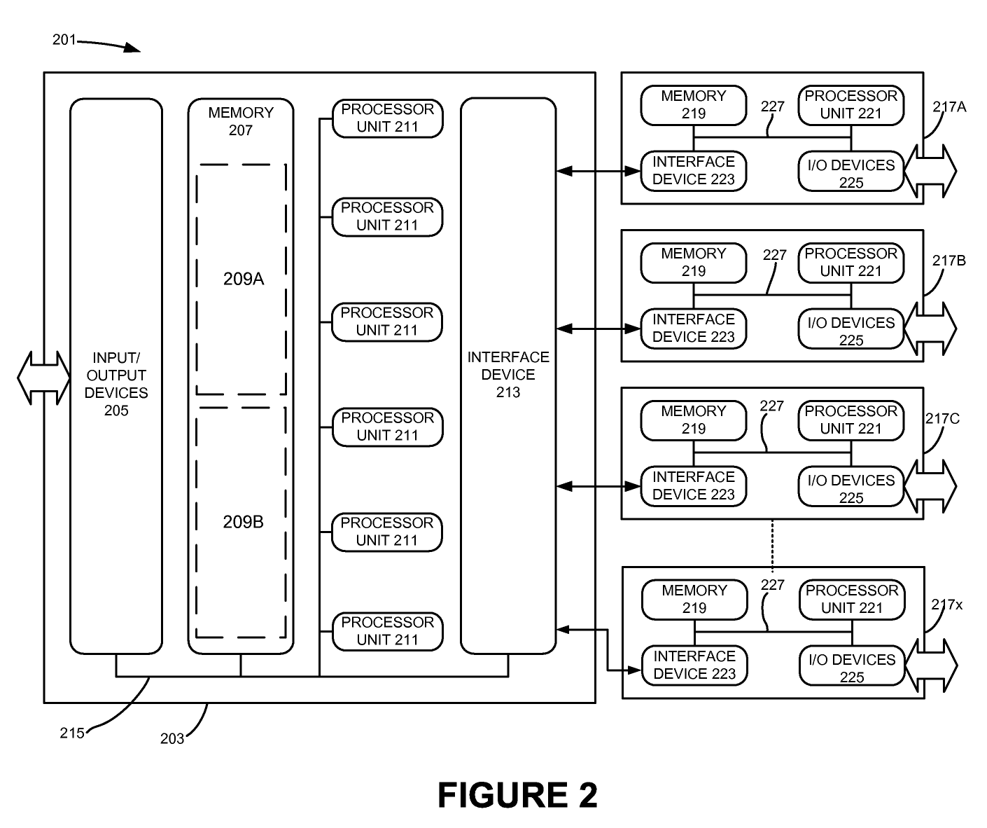

As stated above, various embodiments of the invention are implemented using computer-executable software instructions executed by one or more programmable computing devices. Because these examples of the invention may be implemented using software instructions, the components and operation of a generic programmable computer system on which various embodiments of the invention may be employed is described. Further, because of the complexity of some electronic design automation processes and the large size of many circuit designs, various electronic design automation tools are configured to operate on a computing system capable of simultaneously running multiple processing threads. The components and operation of a computer network 201 having a host or master computer and one or more remote or slave computers therefore will be described with reference to FIG. 2. This operating environment is only one example of a suitable operating environment, however, and is not intended to suggest any limitation as to the scope of use or functionality of the invention.

In FIG. 2, the computer network 201 includes a master computer 203. In the illustrated example, the master computer 203 is a multi-processor computer that includes a plurality of input and output devices 205 and a memory 207. The input and output devices 205 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 207 may similarly be implemented using any combination of computer readable media that can be accessed by the master computer 203. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 203 runs a software application for performing one or more operations according to various examples of the invention. Accordingly, the memory 207 stores software instructions 209A that, when executed, will implement a software application for performing one or more operations. The memory 207 also stores data 209B to be used with the software application. In the illustrated embodiment, the data 209B contains process data that the software application uses to perform the operations, at least some of which may be parallel.

The master computer 203 also includes a plurality of processor units 211 and an interface device 213. The processor units 211 may be any type of processor device that can be programmed to execute the software instructions 209A, but will conventionally be a microprocessor device. For example, one or more of the processor units 211 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 211 may be a custom manufactured processor, such as a microprocessor designed to optimally perform specific types of mathematical operations. The interface device 213, the processor units 211, the memory 207 and the input/output devices 205 are connected together by a bus 215.

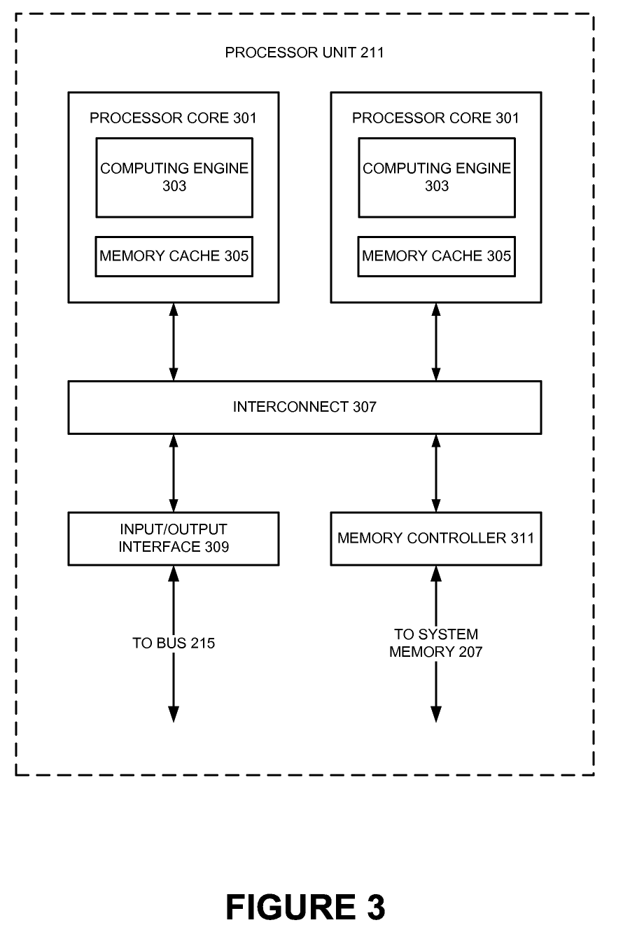

With some implementations of the invention, the master computing device 203 may employ one or more processing units 211 having more than one processor core. Accordingly, FIG. 3 illustrates an example of a multi-core processor unit 211 that may be employed with various embodiments of the invention. As seen in this figure, the processor unit 211 includes a plurality of processor cores 301. Each processor core 301 includes a computing engine 303 and a memory cache 305. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 303 may then use its corresponding memory cache 305 to quickly store and retrieve data and/or instructions for execution.

Each processor core 301 is connected to an interconnect 307. The particular construction of the interconnect 307 may vary depending upon the architecture of the processor unit 301. With some processor cores 301, such as the Cell microprocessor created by Sony Corporation, Toshiba Corporation and IBM Corporation, the interconnect 307 may be implemented as an interconnect bus. With other processor cores 301, however, such as the Opteron™ and Athlon™ dual-core processors available from Advanced Micro Devices of Sunnyvale, Calif., the interconnect 307 may be implemented as a system request interface device. In any case, the processor cores 301 communicate through the interconnect 307 with an input/output interfaces 309 and a memory controller 311. The input/output interface 309 provides a communication interface between the processor unit 211 and the bus 215. Similarly, the memory controller 311 controls the exchange of information between the processor unit 211 and the system memory 207. With some implementations of the invention, the processor units 211 may include additional components, such as a high-level cache memory accessible shared by the processor cores 301.

While FIG. 3 shows one illustration of a processor unit 211 that may be employed by some embodiments of the invention, it should be appreciated that this illustration is representative only, and is not intended to be limiting. For example, some embodiments of the invention may employ a master computer 203 with one or more Cell processors. The Cell processor employs multiple input/output interfaces 309 and multiple memory controllers 311. Also, the Cell processor has nine different processor cores 301 of different types. More particularly, it has six or more synergistic processor elements (SPEs) and a power processor element (PPE). Each synergistic processor element has a vector-type computing engine 203 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 211 can be used in lieu of multiple, separate processor units 211. For example, rather than employing six separate processor units 211, an alternate implementation of the invention may employ a single processor unit 211 having six cores, two multi-core processor units 211 each having three cores, a multi-core processor unit 211 with four cores together with two separate single-core processor units 211, or other desired configuration.

Returning now to FIG. 2, the interface device 213 allows the master computer 203 to communicate with the slave computers 217A, 217B, 217C . . . 217x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 213 translates data and control signals from the master computer 203 and each of the slave computers 217 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 217 may include a memory 219, a processor unit 221, an interface device 223, and, optionally, one more input/output devices 225 connected together by a system bus 227. As with the master computer 203, the optional input/output devices 225 for the slave computers 217 may include any conventional input or output devices, such as keyboards, pointing devices, microphones, display monitors, speakers, and printers. Similarly, the processor units 221 may be any type of conventional or custom-manufactured programmable processor device. For example, one or more of the processor units 221 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 221 may be custom manufactured processors, such as microprocessors designed to optimally perform specific types of mathematical operations. Still further, one or more of the processor units 221 may have more than one core, as described with reference to FIG. 3 above. For example, with some implementations of the invention, one or more of the processor units 221 may be a Cell processor. The memory 219 then may be implemented using any combination of the computer readable media discussed above. Like the interface device 213, the interface devices 223 allow the slave computers 217 to communicate with the master computer 203 over the communication interface.

In the illustrated example, the master computer 203 is a multi-processor unit computer with multiple processor units 211, while each slave computer 217 has a single processor unit 221. It should be noted, however, that alternate implementations of the invention may employ a master computer having single processor unit 211. Further, one or more of the slave computers 217 may have multiple processor units 221, depending upon their intended use, as previously discussed. Also, while only a single interface device 213 or 223 is illustrated for both the master computer 203 and the slave computers 217, it should be noted that, with alternate embodiments of the invention, either the master computer 203, one or more of the slave computers 217, or some combination of both may use two or more different interface devices 213 or 223 for communicating over multiple communication interfaces.

With various examples of the invention, the master computer 203 may be connected to one or more external data storage devices. These external data storage devices may be implemented using any combination of computer readable media that can be accessed by the master computer 203. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 217 may alternately or additions be connected to one or more external data storage devices. Typically, these external data storage devices will include data storage devices that also are connected to the master computer 203, but they also may be different from any data storage devices accessible by the master computer 203.

It also should be appreciated that the description of the computer network illustrated in FIG. 2 and FIG. 3 is provided as an example only and is not intended to suggest any limitation as to the scope of use or functionality of alternate embodiments of the invention.

### Illustrative Electronic Design Automation Tool Implementing Various Embodiments of the Invention

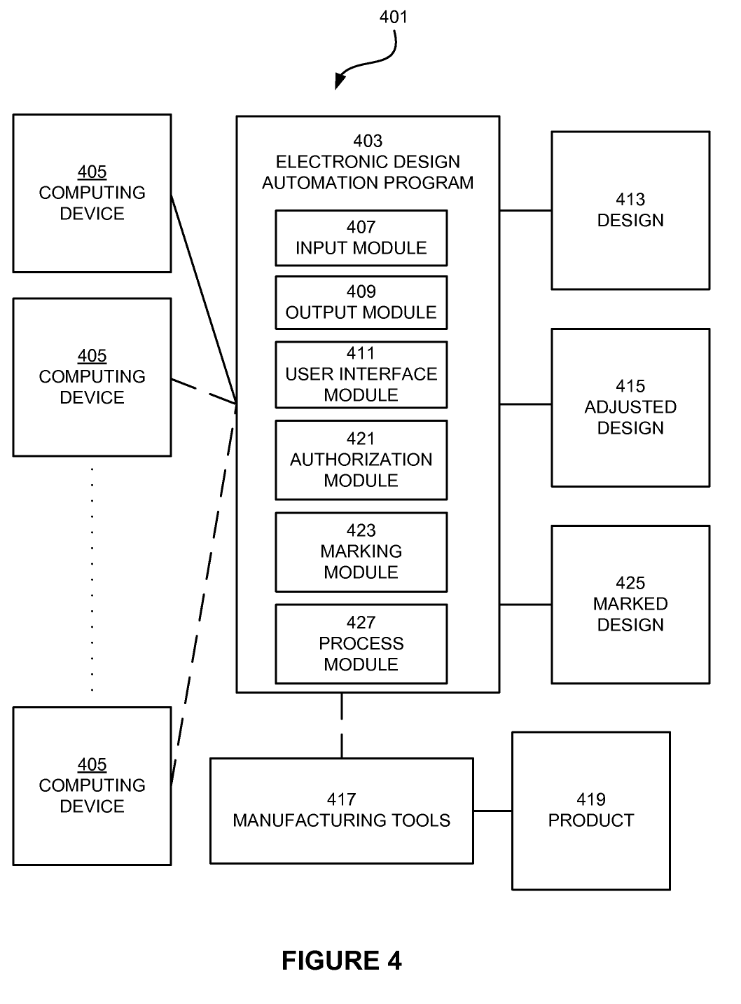

FIG. 4 illustrates an electronic design automation tool 401, which implements various embodiments of the invention. The electronic design automation tool 401 includes an electronic design automation program 403 that is operated on a programmable computing device 405. As can be seen in FIG. 1, the electronic design automation program 403 may be operated on a single programmable computing device 405 or on multiple programmable computing devices 405. The electronic design automation program 403 may further include an input module 407, an output module 409 and a user interface module 411.

With various implementations of the invention, the electronic design automation tool 401 is an automatic trace routing tool for printed circuit board designs. With further implementations of the invention, the electronic design automation program 403 is the Board Station tool available from Mentor Graphics Corporation of Wilsonville, Oreg. In some implementations of the invention, the input module 407 accesses a design 413, the design 413 representing a layout design for a printed circuit board. Following which, the electronic design automation program 403 may route traces within the design 413 according to selected parameters. These selected parameters may be supplied by the user, for example through the user interface module 411. An adjusted design 415, which includes the routed traces, may then be provided by the output module 409, for example by saving the adjusted design 415 to a memory storage location. Still, with various implementations of the invention, the electronic design automation program 403 may have one or more additional process modules 427 that manipulate and adjust the design 413 to produce the adjusted design 415.

In additional or alternate implementations, the electronic design automation program 403 is a printed circuit board layout design editor. Accordingly, the design 413 may represent a layout design file for a printed circuit board. The user interface module 411 may facilitate the placement of components within the design 413, the manual or automatic routing of traces between components within the design 413, and the displaying and manipulation of netlines within the design 413. In other implementations of the invention, the electronic design automation program 403 is an integrated circuit layout design editor. Accordingly, the design 413 may represent a layout design file for an integrated circuit.

The electronic design automation tool 401 may also be used to manufacture a product, for example by providing the design 413 to a manufacturing tool 417, wherein the manufacturing tool 417 will create a product 419 according to the design 413. Alternatively or additionally, the electronic design automation tool 401 may provide the adjusted design 415 to the manufacturing tool 417. Accordingly, the product 419 would be manufactured according to the adjusted design 415.

The electronic design automation program 403 additionally includes an authorization module 421 and a marking module 423. With various implementations, the authorization module 421 checks for the existence of a valid registration number. With other implementations of the invention, the authorization module 421 checks for the existence of a valid license for the electronic design automation program 403. In still further implementations of the invention, the authorization module verifies the integrity of the electronic design automation program 403, which may include detection of reverse engineering, tampering, or attempts to thwart detection of the unauthorized usage of the electronic design automation program 403.

With various implementations of the invention, the electronic design automation tool 401 carries out the process 101 illustrated in FIG. 1. Referring back to FIG. 1, the operation 107 for detecting if performance or execution of the process 101 is authorized may be performed by the authorization module 421. Additionally, the operation 109 for marking the output 105 may be performed by the marking module 423. Accordingly, if the authorization module 421 detects that operation of the electronic design automation program 403 is unauthorized, for example by detecting an invalid license file, the marking module 423 may provide a marked design 425. As indicated above, in various implementations of the invention, the design 413 represents a layout design for a printed circuit board.

Accordingly, the marked design 425 may represent the layout design for a printed circuit board, with various distinguishing features or “marks” added to the design. Alternatively, the marked design 425 may be the adjusted design 415, with various distinguishing features or “marks” added to the design. In further implementations of the invention, the electronic design automation process may provide the marked design 425 to the manufacturing tools 417. Accordingly, the product 419 would be manufactured according to the marked design, which contains the various distinguishing features or “marks.” With various implementations, the marked design 425 is provided to the manufacturing tools 417 when the authorization module 421 detects that the electronic design automation program 403 is being operated without authorization, by for example performing the operation 109.

As many layout design editors and electronic design automation tools, such as the electronic design automation tool 401 and the electronic design automation program 403 are commonly known in the art, a detailed description of their uses, applications and detailed workings is omitted during the balance of this description.

### Illustrative Marking of a Printed Circuit Board Design

As indicated above, the design 413 may represents a layout design for a printed circuit board. Accordingly, the adjusted design 415 would represent the layout design for the printed circuit board with some adjustments, such as the addition of traces and vias.

Additionally, the marked layout design 425 would represent the layout design for the printed circuit board with various distinguishing features or “marks” added and/or with some adjustments, such as the addition of traces and vias.

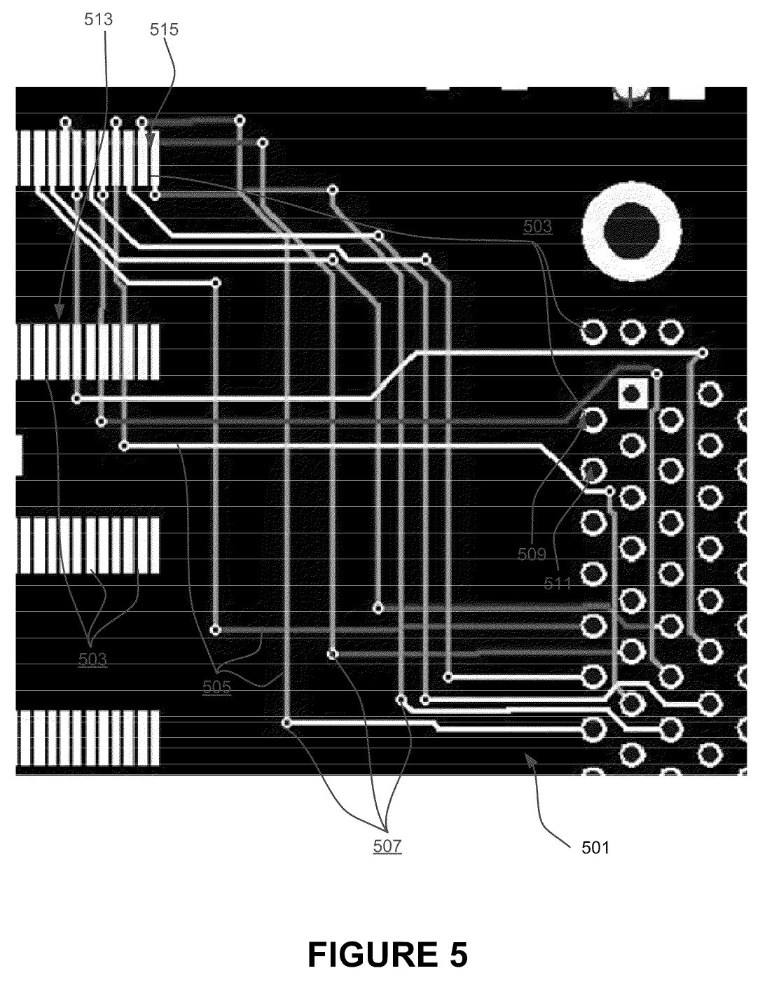

FIG. 5 illustrates a layout design 501, corresponding to a portion of a layout design for a printed circuit board. As stated above, the design 413 may represent a layout design for a printed circuit board, for example the layout design 501. As can be seen in FIG. 5, the layout design 501 includes a plurality of pads 503, a plurality of traces 505, and a plurality of vias 507. With various implementations of the invention, the pads 503 are integrated circuit pads for connection via a ball grid array, such as the pads 509 and 511. With other implementations of the invention, the pads 503 are rectangular component pads, such as the pads 513 and 515. As indicated above, the traces 505, as well as the vias 507 may be added to the layout design 501 manually by the user through the use of a layout design editor or added to the layout design 501 automatically by an automatic trace routing tool. Additionally, the layout design 501 may already have traces present.

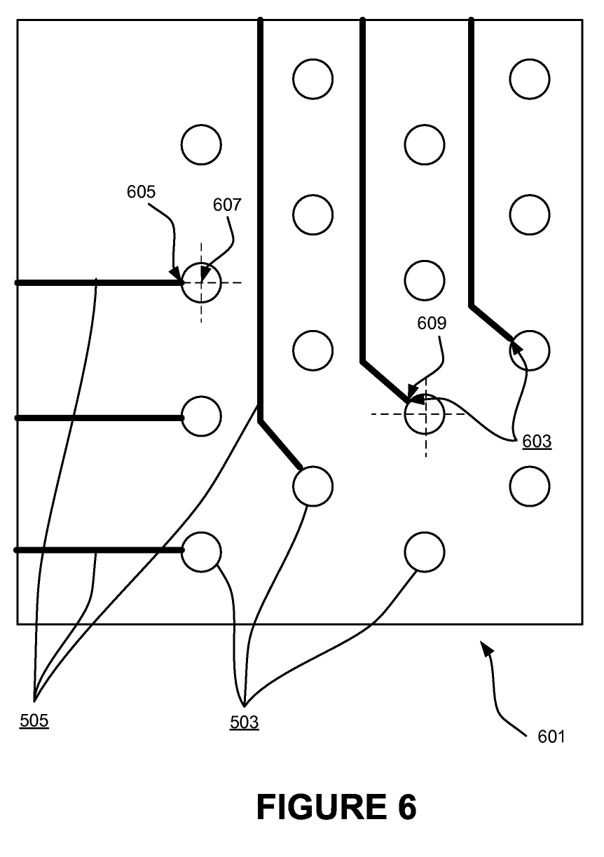

FIG. 6 illustrates a layout design 601, which corresponds to a selected region of the layout design 501. As can be seen in FIG. 6, the layout design 601 contains some of the pads 503, and some of the traces 505. Furthermore, FIG. 6 illustrates pad entries 603. As can be seen, the pad entries 603 indicate the connection between a trace 505 and a pad 503. Printed circuit board design designers and automatic trace routing programs typically cause the pad entries to be centered. More particularly, as the pad entry 605 shows, a centered pad entry directly contacts the pad at the pads midsection or centerline 607. A centered pad entry is often referred to as having no offset or a 0 degree offset. In some printed circuit board design, a pad entry will have a 45 degree offset, as the pad entry 609 illustrates.

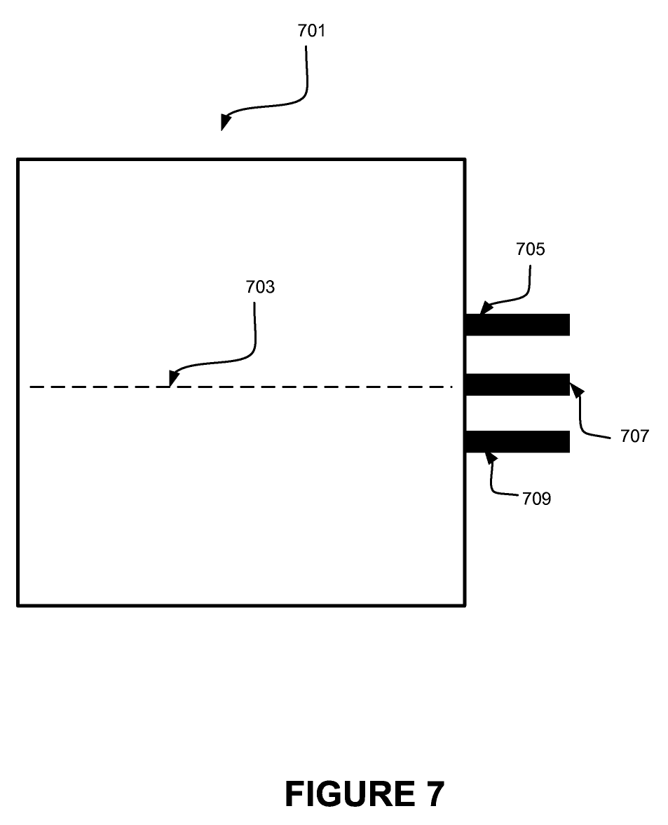

Referring back now to FIG. 4, the marked design 425 created by the marking module 423 and including distinguishing features or “marks,” may be created, by for example the process 101 detailed in FIG. 1. With some implementations of the invention, the marking module 423 adjusts the offset of the pad entries. For example, the pad entries 603 of FIG. 6 may be adjusted. FIG. 7 illustrates a pad 701, having a center line 703. Additionally, a pad entry 705, a pad entry 707, and a pad entry 709 are shown. As can be seen in FIG. 7, the pad entry 707 is centered on the pad 701. Accordingly, the pad entry 707 has no offset. As can be further seen from FIG. 7, the pad entry 705, and the pad entry 709 are not centered on the pad 701, and accordingly have an offset value. Although three pad entries for a single pad are shown, it will be appreciated that normally a pad has a single pad entry. Here multiple pad entries are illustrated for the purpose of showing the pad entry offset. However, there are circumstances where a pad will have multiple entries, and the teachings discussed herein may be generalized to a pad having multiple pad entries.

In various implementations of the invention, each pad entry within the design 413 or the adjusted design 415 is offset to form the marked design 425. For example, the pad entries may be offset a predetermined value, such as 1 nanometer. With other implementations of the invention, the width of the trace is adjusted a predetermined value, resulting in the marked design 425 having traces with widths of a predetermined specified value. With still further implementations of the invention, the pad entries are offset in a predetermined manner according to a code. For example, FIG. 7 illustrates three pad entries having a different offset value. Accordingly, a value or code word could be assigned to each different offset. More particularly, pad entry 707, having no offset could signify a number, or a letter, such as “M”. Additionally, the pad entry 705, having a positive offset, measured in degrees from the center line, could signify a different number, or a different letter, such as “G”. Further still, the pad entry 709, having a negative offset, measured in degrees from the center line, could signify a still different number, or a still different letter, such as “C”.

With various implementations of the invention, a pad entry 603 having a 45 degree offset, such as the pad entry 609 will be considered centered. Accordingly a pad entry will be considered neutral if it is centered at 45 degrees. Additionally, a pad entry may be considered positive or negative depending upon its offset 45 degrees from the center line.

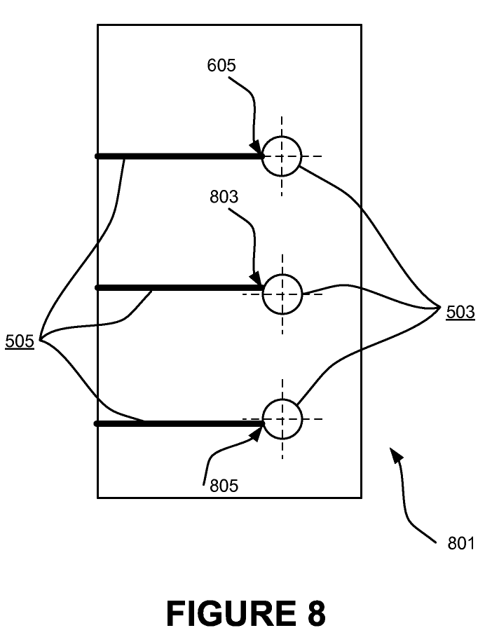

FIG. 8 illustrates a layout design 801, which corresponds to a selected region of the layout design 601 shown in FIG. 6. The layout design 801 contains some of the pads 503, some of the traces 505, the pad entry 605, a pad entry 803, and a pad entry 805. As can be seen from FIG. 8, the pad entry 605 is neutral, i.e. has no offset from the center line, the pad entry 803 has a positive offset, and the pad entry 805 has a negative offset. Employing the code described above, the pad entries 605, 803, and 805 may be deciphered to spell “MGC”. Accordingly, the layout design 801 contains distinguishing features or “marks” that may be used to uniquely identify the layout design 801 and a product, more particularly a printed circuit board, manufactured according to the layout design 801.

Returning again to FIG. 1, the process 101 contains the operation 109 for marking the process output if it has been detected that the process is being operated without authorization. In various implementations of the invention, a code system similar to that described above may be employed to “mark” the output 105. With some implementations of the invention, the code is a ternary code. For example, the first ternary value may be indicated by a neutral offset, the second ternary value by a positive offset, and the third ternary value by a negative offset. With further implementations of the invention, the code is a three digit ternary code. For example, three consecutive pads, such as the pads 503 shown in the layout design 801 may represent a three digit ternary code. A three digit ternary code is significant because it provides for a mapping to the 26 characters in the English alphabet. Accordingly, a row of 18 pads may be used to code the word “MENTOR,” or some other appropriate code word.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A method for marking design data comprising:
identifying a portion of design data,
the portion of design data representing an electronic device design, and
the portion of design data containing a plurality of design features;
selecting one or more of the plurality of design features;
identifying a plurality of discreet adjustments applicable to the selected one or more of the plurality of design features;
identifying a condition;
detecting an occurrence of the condition; and
generating one or more marked design features by applying the plurality of discreet adjustments to the selected one or more of the plurality of design features.

2. The method recited in claim 1, the plurality of discreet adjustments representing a code.

3. The method recited in claim 2, the one or more marked design features being distinguishable from the selected one or more of the plurality of design features by the code.

4. The method recited in claim 3, the electronic device design being a design for a printed circuit board.

5. The method recited in claim 4, the selected one or more of the plurality of design features being pads within the design for the printed circuit board, the pads having an offset.

6. The method recited in claim 5, the plurality of discreet adjustments changing the offset.

7. The method recited in claim 6, the code being a ternary code corresponding to:
an offset of −1;
an offset of 0; and
an offset of +1.

8. The method recited in claim 1, further comprising:
storing the portion of design data containing the one or more marked design features to a memory storage location.

9. The method recited in claim 8, further comprising:
manufacturing an electronic device according to the portion of design data containing the one or more marked design features.

10. The method recited in claim 1, the condition being an unauthorized license.

11. A computer program product for enabling a computer to alter a portion of a layout design comprising:
software instructions for enabling a computer to perform a set of predetermined operations; and
one or more computer readable storage medium bearing the software instructions;
the set of predetermined operations including:
identifying a portion of design data,
the portion of design data representing an electronic device design, and
the portion of design data containing a plurality of design features;
selecting one or more of the plurality of design features;
identifying a plurality of discreet adjustments applicable to the selected one or more of the plurality of design features;
identifying a condition;
detecting an occurrence of the condition; and
generating one or more marked design features by applying the plurality of discreet adjustments to the selected one or more of the plurality of design features.

12. The computer program product recited in claim 11, the set of predetermined operation further comprising:
storing the manipulated design data to a memory storage location.

13. The computer program product recited in claim 12, the plurality of discreet adjustments representing a code.

14. The method recited in claim 13, the one or more marked design features being distinguishable from the selected one or more of the plurality of design features by the code.

15. The method recited in claim 14, the electronic device design being a design for a printed circuit board.

16. The method recited in claim 15, the selected one or more of the plurality of design features being pads within the design for the printed circuit board, the pads having an offset.

17. The method recited in claim 16, the plurality of discreet adjustments changing the offset.

18. The method recited in claim 17, the code being a ternary code corresponding to:
an offset of −1;
an offset of 0; and
an offset of +1.

19. The method recited in claim 12, further comprising:
manufacturing an electronic device according to the portion of design data containing the one or more marked design features.

20. The method recited in claim 11, the condition being an unauthorized license.

21. A computer system adapted to manipulate design data comprising:
a processor; and
a memory including software instructions that cause the computer system to perform operations including:
identifying a portion of design data,
the portion of design data representing an electronic device design, and
the portion of design data containing a plurality of design features;
selecting one or more of the plurality of design features;
identifying a plurality of discreet adjustments applicable to the selected one or more of the plurality of design features;
identifying a condition;
detecting an occurrence of the condition; and
generating one or more marked design features by applying the plurality of discreet adjustments to the selected one or more of the plurality of design features.

22. The computer system recited in claim 21, the set of instructions further comprising:
storing the manipulated design data to a memory storage location.

23. The computer system recited in claim 22, the plurality of discreet adjustments representing a code.

24. The computer system recited in claim 23, the one or more marked design features being distinguishable from the selected one or more of the plurality of design features by the code.

25. The computer system recited in claim 24, the electronic device design being a design for a printed circuit board.

26. The computer system recited in claim 25, the selected one or more of the plurality of design features being pads within the design for the printed circuit board, the pads having an offset.

27. The computer system recited in claim 26, the plurality of discreet adjustments changing the offset.

28. The method recited in claim 27, the code being a ternary code corresponding to:
an offset of −1;
an offset of 0; and
an offset of +1.

29. The method recited in claim 22, further comprising:
manufacturing an electronic device according to the portion of design data containing the one or more marked design features.

30. The method recited in claim 21, the condition being an unauthorized license.
